(19) United States
(12) Patent Application Publication
(10) Pub. No.: US 2002/0143622 A1
(43) Pub. Date: Oct. 3, 2002

(54) Method for licensing three-dimensional avatars

(76) Inventors: Andr?eacute; Taliercio, New York, NY (US); Isabelle Pesquié-Geday, New York, NY (US)

Correspondence Address: PENNIE AND EDMONDS, 1155 AVENUE OF THE AMERICAS, NEW YORK, NY, 100362711

(21) Appl. No.: 09/823,320

(22) Filed: Apr. 2, 2001

(51) Int. Cl. G06F 17/60; G06T 15/00

(52) U.S. Cl. 705/14; 705/1; 345/419

(57) ABSTRACT

A method for licensing and promoting the three-dimensional avatars of individuals is disclosed. In one embodiment, a method includes generating a three-dimensional avatar of an individual and licensing rights to the three-dimensional avatar to an e-agent. This method may further include transacting a contract between the e-agent and a party seeking to license the three-dimensional avatar for a specified use. The three-dimensional avatar may be viewed through a public network such as the Internet.

### TECHNICAL FIELD

This invention relates generally to methods for licensing and promoting three-dimensional avatars of individuals, preferably well-known individuals.

### BACKGROUND OF THE INVENTION

The use of celebrities or other well-known persons to promote products and services is an established sales and marketing tool. For example, such persons may make personal appearances, appear in television advertisements, or allow their likenesses to be used in printed advertisements. Sellers of products and services desire such services from well-known individuals to create a particular brand image or identity for their product or company. Such activities can generate significant income for these well-known individuals and can have a significant impact on the sales of a product or service.

But a particular individual's ability to take part in such promotional activities is limited by the number of physical appearances that the person can make. Even the use of recorded appearances, such as television commercials, does not completely solve this problem because their creation requires the personal involvement of the individual retained to promote the product or service. For such individuals, whose promotional services are in high demand, conflicts with personal and professional schedules can result in lost marketing opportunities, with an attendant loss in income for the individual and lost sales for the entity promoting and selling the goods or service.

Therefore, a method is needed to allow persons to make virtual “personal appearances” through the use of three-dimensional avatars and to license the use of such avatars.

### SUMMARY OF THE INVENTION

The present invention is directed towards a method for licensing and promoting the three-dimensional avatars of individuals. Avatars are electronic representations of an actual person that mimic a particular person's characteristics, such as their physical appearance, manner of movement, facial expressions, voice, etc.

Once this three-dimensional avatar is created it may be used in the place of the actual individual to promote, endorse, or market a company, product, or service over the Internet or other electronic medium, such as television, film, or video. The avatar may either be a realistic representation of the individual or a cartoon-like representation. In either case, the goal is to create a software version of the individual that is recognizable as that individual.

In one embodiment, a method of licensing three-dimensional avatars of well-known individuals includes generating a three-dimensional avatar of a well-known individual and licensing rights to the three-dimensional avatar to an e-agent.

This method may further include transacting a contract between the e-agent and a party seeking to license the three-dimensional avatar for a specified use. The specified use may be a virtual fashion show. The specified use may also be virtual interaction with the three-dimensional avatar. An individual may interact with the three-dimensional avatar using keyboard commands. An individual may also interact with the three-dimensional avatar using speech. The party seeking to license the three-dimensional avatar may provide compensation to the well-known individual. The compensation may be in the form of a flat fee, the number of times the three-dimensional avatar is displayed, a percentage of a specified economic measure, or some other agreed-upon measure.

The e-agent may receive compensation for promoting the three-dimensional avatar.

The method may further include licensing other promotional rights of the well-known individual to the e-agent. These other promotional rights may include any number of rights such as, personal appearances by the individual, the individual's likeness, or the individual's name.

The three-dimensional avatar may be viewed through a public network such as the Internet.

Other features and advantages of the present invention will be readily apparent from the following detailed description of the invention.

### BRIEF DESCRIPTION OF THE DRAWINGS

The detailed description will be better understood in conjunction with the accompanying drawings:

FIG. 1 is a block diagram of the general processes used to create a three-dimensional avatar an individual.

FIG. 2 is a block diagram of the method according to the present invention for licensing the rights to a three-dimensional avatar of an individual.

### DETAILED DESCRIPTION OF THE PREFERRED EMBODIMENTS OF THE INVENTION

The present invention describes a method for licensing three-dimensional avatars of an individual to substitute for the actual individual. The advantage of using a three-dimensional avatar to substitute for the actual individual is that it allows the individual to maximize the individual's exposure with a minimum amount of personal involvement. For example, certain individuals'professional and promotional services are in high demand. Such high-demand individuals may have to forego certain activities because of conflicts with personal and professional schedules. The present invention permits an individual to take part in promotional activities with minimal conflict with personal and professional schedules through the licensed use of a three-dimensional avatar.

The individual's three-dimensional avatar may be animated to perform any number of actions or tasks. A three-dimensional avatar licensed through the method of the present invention may be used in any number of possible situations to substitute for an actual individual. For example, three-dimensional avatars of fashion models may be used to create an online fashion show. Such avatars could also be used in place of the actual individuals in advertisements, movies, and televisions shows. Another potential use is where individuals may interact with the three-dimensional avatar by asking the avatar questions or directing the avatar to perform certain actions. This software rendition of an individual may be used also to promote, endorse, or market a company, product, or service over the Internet or other electronic medium.

Thus, for example, a person may view the three-dimensional avatar by connecting to a public network such as the Internet via a remote computer system and displaying a Web page using a Web browser. The remote computer systems may include systems known in the art, such as desktop computers employing modems, or wireless devices such as cellular phones.

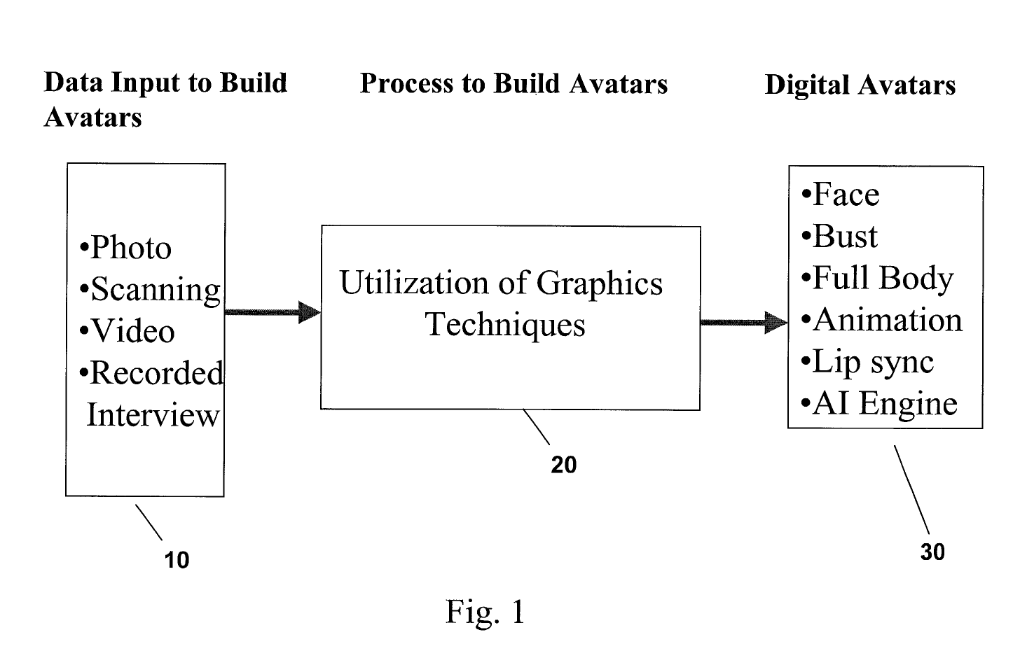

FIG. 1 generally depicts one process by which a three-dimensional avatar of a individual is created. Other suitable methods may be used to create the three-dimensional avatar that is used with the present invention. To create this three-dimensional avatar any number of known techniques may be used. For example, techniques to reproduce a person's appearance and facial movements are described in U.S. Pat. Nos. 5,969,721, 5,995,119, and 6,031,539.

First, various data concerning the appearance of the individual are collected 10. Preferably, the face and body of the individual are photographed from a number of different directions so as to capture all the necessary physical characteristics. The individual's various facial and body motions and voice characteristics may also be recorded and studied for use in creating the avatar. Known methods may be used to generate the bone and muscle structure of the avatar, onto which is mapped the outer appearance of the individual 20.

Next, various animations are created to reproduce the individual's speech patterns, facial expressions, and body movements. Using the collected data, various representations of the person's facial features and lips are created, each of which correspond to a particular phoneme or sound. Additional facial expressions corresponding to various emotional states, such as anger, happiness, sadness and so on, are created.

All of these elements are assembled to create a three-dimensional avatar of an actual person 30. This three-dimensional avatar has the same appearance and physical characteristics of the actual individual upon which it is based, with the ability to move and speak naturally. Once the avatar is created it may be animated in any number of ways depending on the task that is required. In effect, the avatar can substitute for the actual person.

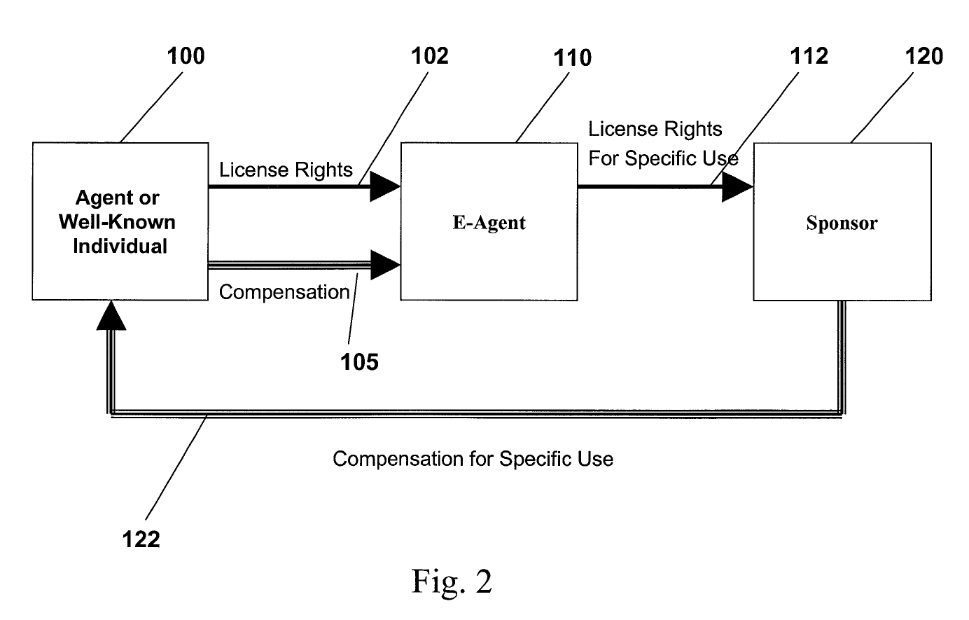

FIG. 2 depicts a method according to the present invention for licensing rights to the three-dimensional avatars of well-known individuals. Typically, well-known individuals 100 are paid for their services based on their physical presence and the use of their likenesses for endorsements. The careers of such individuals are normally managed through agents 100, who receive a percentage of the fees paid to their clients. In one embodiment of the licensing method of this invention, the well-known individual 100 or the individual's agent 100 will license rights 102 to that individual's three-dimensional avatar to an e-agent 110, preferably a separate licensing entity created to manage and promote the use of the three-dimensional avatar 112. In another embodiment of the present invention, the e-agent 110 also has the right to promote and manage other promotional rights of the well-known individual 100 in addition to that individual's three-dimensional avatar. For example, it is possible for the e-agent 110 to have the right to promote the personal or television appearances of well-known individual 100, or the individual's likeness or name.

The e-agent 110 is preferably compensated for managing and promoting the three-dimensional avatar of a well-known individual 100. Typically, the compensation 105 to the e-agent 110 is based on a percentage of the revenue derived from the licensing of the rights to use the three-dimensional avatar for a specified purpose. The e-agent may receive compensation from either the well-known individual 100 or the sponsor 120. Other compensation arrangements for the e-agent are possible.

For example, a particular sponsor 120 may wish to retain the services of a certain well-known individual 100 to promote the sponsor's product in a commercial. Instead of retaining the personal services of this well-known individual 100, in this example the sponsor 120 decides to license the use of this individual's three-dimensional avatar to appear in a commercial. Accordingly, the sponsor 120 contracts with the e-agent 110 to use the three-dimensional avatar. A specific use of the avatar will be defined, along with any other necessary restrictions and terms of payment 112.

Compensation 122 for use of the three-dimensional avatar may be computed in a number of ways. By way of example, the sponsor 120 may pay a one-time flat fee for use of the avatar for a particular time period. Alternatively, the sponsor 120 may instead pay a fee each time the avatar is displayed during a television commercial or on a Web page. In another embodiment, the sponsor 120 may agree to pay for the use of the avatar based on a percentage of some specified economic measure, such as the sales of the product being promoted. Other payment arrangements are, of course, possible.

The presently disclosed embodiments are considered in all respects to be illustrative and not restrictive. Accordingly, the scope of the invention is indicated by the claims that follow, and is not limited to the foregoing description.

What is claimed is:

1. A method of licensing three-dimensional avatars of individuals, comprising:
(a) generating a three-dimensional avatar of an individual; and
(b) licensing rights to the three-dimensional avatar to an e-agent.

2. The method of claim 1, further comprising transacting a contract between the e-agent and a party seeking to license the three-dimensional avatar for a specified use.

3. The method of claim 1, wherein the e-agent receives compensation from the individual or the party seeking to license the three-dimensional avatar.

4. The method of claim 2, wherein the party seeking to license the three-dimensional avatar provides compensation to the individual.

5. The method of claim 2, wherein the specified use is a virtual fashion show.

6. The method of claim 2, wherein the specified use is virtual interaction with the three-dimensional avatar.

7. The method of claim 6, wherein a person interacts with the three-dimensional avatar using a keyboard.

8. The method of claim 6, wherein a person interacts with the three-dimensional avatar using speech.

9. The method of claim 3, further comprising the step of transacting a contract between the e-agent and a party seeking to license the three-dimensional avatar for a specified use.

10. The method of claim 4, wherein the compensation is a flat fee.

11. The method of claim 4, wherein the compensation is based on the number of times the three-dimensional avatar is displayed.

12. The method of claim 4, wherein the compensation is based upon a percentage of a specified economic measure.

13. The method of claim 1, further comprising licensing promotional rights of the individual in additional to the individual's three-dimensional avatar to the e-agent.

14. The method of claim 2, wherein the three-dimensional avatar may be viewed through a public network.

15. The method of claim 14, wherein the public network is the Internet.

16. The method of claim 14, wherein the three-dimensional avatar is viewed using a Web browser.

17. The method of claim 14, wherein the public network is a wireless telephone network.

18. The method of claim 2, wherein the three-dimensional avatar is viewed using a computer.
